(19) United States
(12) Patent Application Publication
(10) Pub. No.: US 2002/0186931 A1
(43) Pub. Date: Dec. 12, 2002

(54) Housing for optical connector and optical connector

(76) Inventors: Koji Seo, Tokyo (JP); Kazuhiro Takayama, Tokyo (JP); Tomotaka Inoue, Tokyo (JP)

Correspondence Address: KNOBBE MARTENS OLSON & BEAR LLP, 2040 MAIN STREET, FOURTEENTH FLOOR, IRVINE, CA, 91614, US

(21) Appl. No.: 09/981,489

(22) Filed: Oct. 16, 2001

(30) Foreign Application Priority Data
Apr. 20, 2001 (JP) 2001-123095
Aug. 16, 2001 (JP) 2001-247488

(51) Int. Cl. G02B 6/38; G02B 6/36

(52) U.S. Cl. 385/60; 385/58; 385/78; 385/76

(57) ABSTRACT

The position of a ferrule which has been accommodated in a housing for an optical connector of the present invention is uniquely determined within the housing before connection to a mating ferrule. After connection to the mating ferrule, the ferrule is put in a floating condition in the housing. An optical connector of the present invention is constituted by accommodating a ferrule fixing at least an optical fiber in the housing for an optical connector, and the housing and the ferrule do not come into contact with each other even when the housing for an optical connector is inclined.

### FIELD OF THE INVENTION

The present invention relates to an optical connector and a constituent component for the optical connector.

### BACKGROUND OF THE INVENTION

Conventionally, various optical connectors have been developed. As one of the conventional optical connectors, there is an optical connector which accommodates a ferrule with which at least an optical fiber is fixed in a housing. In an optical connector of this type, the ferrule is accommodated in an accommodating section of a housing. Also, the ferrule accommodated in the accommodating section is movable in an axial direction of the optical fiber fixed to the ferrule. Furthermore, the ferrule accommodated in the accommodating section is always pushed forward in the axial direction of the optical fiber by a coil spring.

In order to connect optical connectors of this type to each other, the following process is performed. Two optical connectors are inserted into a cylindrical adapter for connection individually from both ends, in a longitudinal direction, of the adapter. Next, the two optical connectors which have been inserted into the adapter for connection are caused to approach to each other and ferrule end faces of the respective ferrules are caused to butt to each other. Thus, the optical fibers fixed in the ferrules are optically connected to each other.

### SUMMARY OF THE INVENTION

An object of the present invention is to provide an optical connector where connection/disconnection can be further smoothly and securely conducted. Another object of the present invention is to provide an optical connector which can secure more stable connection.

According to one aspect of the present invention, there is provided a housing for an optical connector, comprising:

(1) an accommodating section which accommodates a ferrule fixing plural optical fibers so as to be movable in an axial direction of the optical fiber; and

(2) an expanded space which is provided in the accommodating section and which is formed by a positioning face which can come into contact with a front face of a collar part of the ferrule to be capable of positioning the ferrule and at least one tapered face formed expanding outwardly from the positioning face rearward in the axial direction of the optical fiber, wherein

(3) when the front face of the collar part of the ferrule accommodated in the accommodating section separates from the positioning face, the collar part is put in non-contacting state with an inner peripheral face of the accommodating section in the expanded space.

According to another aspect of the present invention, there is provided an optical connector, wherein

(1) an expanded space which is provided in the accommodating section and which is formed by a positioning face which can come into contact with a front face of a collar part of a ferrule to be capable of positioning the ferrule and at least one taper face expanding outwardly from the positioning face rearward in an axial direction of an optical fiber;

(2) the ferrule accommodated in the accommodating section is movable in the axial direction of the optical fiber,

(3) before connection of another optical connector, the front face of the collar part of the ferrule comes in contact with the positioning face, and

(4) after connection of the another optical connector, the front face of the collar part of the ferrule separates from the positioning face and the collar part is put in non-contacting state with an inner peripheral face of the accommodating section in the expanded space.

According to still another aspect of the present invention, there is provided an optical connector, wherein

(1) a positioning face which can come in contact with a front face of a collar part of a ferrule to be capable of positioning the ferrule is formed within an accommodating section of a housing for an optical connector,

(2) an outer peripheral face of the collar part of the ferrule is formed in a tapered shape expanding outwardly from a side of a ferrule end face towards the opposite side thereof,

(3) the ferrule accommodated in the accommodating section is movable in an axial direction of the optical fiber,

(4) before connection to another optical connector, the front face of the collar part of the ferrule comes in contact with the positioning face and an outer peripheral face comes in contact with an inner peripheral face of the accommodating section, and

(5) after connection to another optical connector, the front face of the collar part of the ferrule separates from the positioning face and the outer peripheral face separates from the inner peripheral face of the accommodating section.

According to another aspect of the present invention, there is provided an optical connector, wherein

(1) a ferrule fixing plural optical fibers is accommodated in an accommodating section of a housing for an optical connector,

(2) the ferrule accommodated in the accommodating section is movable in an axial direction of the optical fiber,

(3) a clearance is provided between an inner peripheral face of the accommodating section and an outer peripheral face of the ferrule, and

(4) the clearance is set to be such a size that, even when the optical connector which has been inserted into an adapter for connection inclines within the adapter in the maximum range, the inner peripheral face of the accommodating section does not come in contact with the outer peripheral face of the ferrule.

### BRIEF DESCRIPTION OF THE DRAWINGS

FIG. 1A is a diagram showing an embodiment of an optical connector of the present invention, in a previous state of connection to another optical connector;

FIG. 1B is a diagram showing the embodiment of the optical connector of the present invention, in a later state of the connection to another optical connector;

FIG. 2A is a diagram showing another embodiment of an optical connector of the present invention, in a later state of connection to another optical connector;

FIG. 2B is a diagram showing an embodiment of optical connectors of the present invention, in a later state of connection to anther optical connector;

FIG. 3A is a diagram showing a step for connecting the optical connectors shown in FIG. 1A, showing a state of the optical connectors before connection with each other;

FIG. 3B is a diagram showing another step for connecting the optical connectors shown in FIG. 1A, showing a state of the optical connectors after connection with each other;

FIG. 4A is a diagram showing a state where a ferrule has inclined at a time of disconnection of the optical connectors shown in FIG. 3B;

FIG. 4B is a diagram showing a state where the inclined ferrule shown in FIG. 4A has been fixed;

FIG. 5 is a diagram showing another embodiment of an optical connector of the present invention;

FIG. 6 is a diagram showing a state where the optical connectors shown in FIG. 5 have been connected to each other using an adapter for connection;

FIG. 7 is a diagram showing design parameters of the optical connector shown in FIG. 5; and

FIG. 8 is a diagram showing still another embodiment of an optical connector of the present invention.

### PREFERRED EMBODIMENTS OF THE INVENTION

[First Embodiment]

Embodiments of an optical connector of the present invention will be explained below. An optical connector shown here is one where a ferrule fixing plural optical fibers by adhesive is accommodated in a housing for an optical connector.

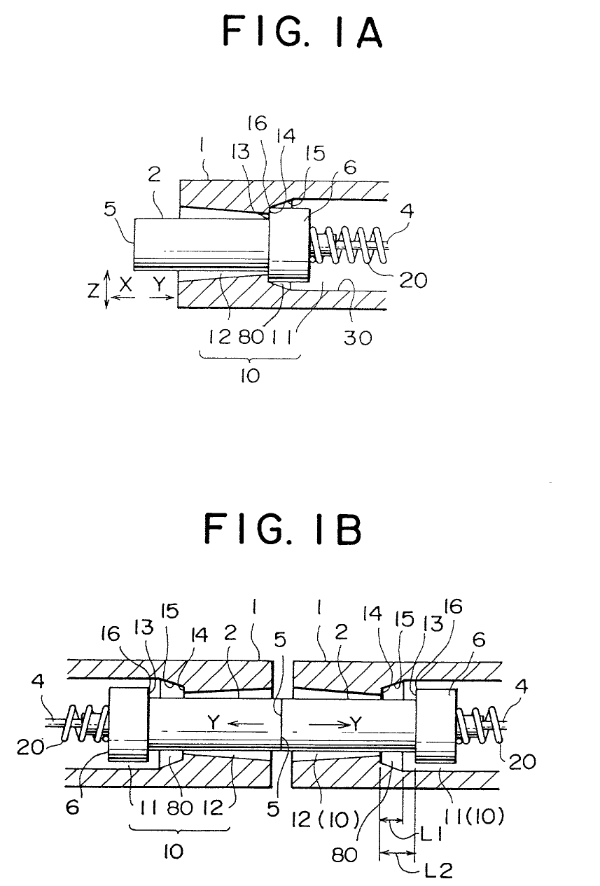

As shown in FIG. 1A, the ferrule 2 has plural fiber holes (not shown) into which an optical fiber 4 can be inserted, and a ferrule end face 5 through which an end face 5 of the optical fibers 4 which has been inserted into the fiber holes is exposed outside. Also, the ferrule 2 is provided with a collar part 6 whose outer diameter is larger than those of other parts of the ferrule 2. When the ferrule end face 5 of said ferrule 2 is caused to butt on another ferrule end face 5 of the ferrule 2, as shown in FIG. 1B, end faces of the optical fibers 4 attached to the respective ferrules 2 are caused to butt on each other and the optical fibers 4 are optically connected to each other.

As shown in FIG. 1A, the housing 1 for an optical connector is formed as a cylinder with substantially rectangular shape, and a accommodating section 10 which can accommodate the ferrule 2 is provided inside the housing 1. The accommodating section 10 is provided with a large space 11 which can accommodate the collar part 6 of the ferrule 2 and a small space 12 which is formed ahead of the large space 11. The large space 11 communicates with the outside via an opening portion (not shown), and the ferrule 2 is inserted into the accommodating section 10 via the opening portion. The small space 12 is formed such that its inner diameter size is gradually expanded from the side of the large space 11 towards the opposite side thereof. The ferrule 2 which has been accommodated in the accommodating section 10 can reciprocate in an axial direction of the optical fiber 4, and is always pushed to a ferrule end face 5 (arrow X direction in FIG. 1A) by a coil spring 20. The coil spring 20 is wound around the optical fiber 4 attached to the ferrule 2.

As shown in FIG. 1A, a positioning face 14 which can contact with a front face 13 of the collar part 6 of the ferrule 2 is formed between the large space 11 and the small space 12. An expanded space 80 is formed between the positioning face 14 and the large space 11 by two tapered faces 15 expanding gradually from the end portion of the positioning face 14 towards the larger space 11. In a state where the front face 13 is contacting with the positioning face 14 (a state shown in FIG. 1A), the tapered faces 15 contact with a corner 16 of the front face 13. On the other hand, in a state where the front face 13 is separated from the positioning face 14 (state shown in FIG. 1B), the tapered faces 15 are put in non-contacting state with the corner 16. Accordingly, while the front face 13 of the collar part 6 is contacting with the positioning face 14, the ferrule 2 is restricted such that it can not move in a direction (arrow Z direction in FIG. 1A) perpendicular to the axial direction (arrow X direction and arrow Y direction in FIG. 1A) of the optical fiber 4. Meanwhile, when the front face 13 of the collar part 6 separates from the positioning face 14, the restriction acting on the ferrule 2 is released.

With the above structure, before the ferrule 2 is connected to a mating ferrule 2 (FIG. 1A), the front face 13 of the collar part 6 is pushed to the positioning face 14 by pushing force of the coil spring 20, so that the ferrule 2 is prevented from moving in the arrow X direction. Also, by pushing force of the coil spring 20, the ferrule 2 is prevented from moving in the arrow Y direction. Furthermore, the corner 16 of the front face 13 contacts with the tapered faces 15 so that the ferrule 2 is prevented from moving in the arrow direction Z. Briefly speaking, before the ferrule 2 is connected to the mating ferrule 2, the optical fibers 4 fixed in the ferrule 2 is prevented from moving in all directions of the forward and rearward directions of the optical fiber 4 and the direction perpendicular to these directions. As a result, the position of the ferrule 2 is uniquely defined within the accommodating section 10 of the housing 1 for an optical connector. On the other hand, after the ferrule 2 has been connected to the mating ferrule 2 (FIG. 1B), since the ferrule 2 is pushed in the arrow Y direction by the mating ferrule 2, it is moved backward in the arrow Y direction against the pushing force of the coil spring 20. When the ferrule 2 is moved backward, the front face 13 of the collar part 6 separates from the positioning face 14 and the corner 16 of the front face 13 also separates from the tapered faces 15. Accordingly, all the obstructions are canceled or released. As a result, a sufficient clearance occurs between the ferrule 2 and the housing 1 for an optical connector so that the ferrule 2 is put in a floating condition within the accommodating section 10.

The clearance is set to have such a size that, even when the housing 1 for an optical connector inclines by any external force, an inner peripheral face 30 does not come in contact with the ferrule 2.

The length of the tapered face 15 (shown with L1 in FIG. 1B) is set to be shorter than the distance of rearward movement of the ferrule 2 (shown with L2 in FIG. 1B). Therefore, after the connection to the mating ferrule 2, the corner 16 of the front face 13 securely moves within the expanded space 80 so that a sufficient clearance occurs between the ferrule 2 and the housing 1 for an optical connector.

Even in the state where the front face 13 is in contact with the positioning face 14 (the state shown in FIG. 1A), a slight clearance occurs between the corner 16 of the front face 13 and the tapered face 15 in some cases. In such a case, there is a possibility that the ferrule 2 moves in the arrow Z direction in FIG. 1A within the rage of the above clearance. However, since this clearance is extremely small, the amount of movement of the ferrule 2 is in an allowable range.

In the optical connector shown in FIGS. 1A and 1B, the tapered faces 15 are formed on upper and lower sides of the expanded space 80, but they may be formed on both sides, in a transverse direction, of the expanded space 80. Also, the tapered faces 15 may be formed on upper, lower and both widthwise sides of the expanded space 80.

[Second Embodiment]

Another embodiment of an optical connector of the present invention will be explained below. A basic structure of an optical connector shown herein is the same as that of the optical connector with the first embodiment. Both the embodiments are different in the following two points.

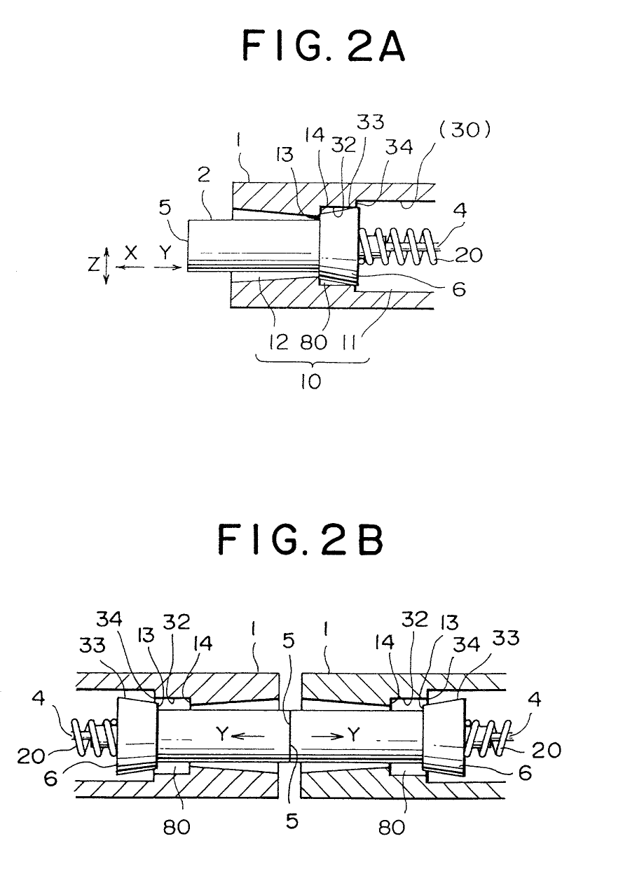

(1) As shown in FIG. 2A, an outer peripheral face 33 of the collar part 6 of the ferrule 2 is tapered so as to expand gradually from the side of the ferrule end face 5 towards an opposite side thereto.

(2) As shown in FIG. 2A, an expanded space 80 formed so as to have horizontal faces 32 parallel to the inner peripheral face 30 of the large space 11 is provided between a positioning face 14 of the housing 1 for an optical connector and the large space 11. Briefly speaking, the tapered face 15 shown in FIGS. 1A and 1B is formed in a face parallel to the inner peripheral face 30 of the large space 11.

In a state where the front face 13 of the collar part 6 is in contact with the positioning face 14 (a state shown in FIG. 2A), the outer peripheral face 33 of the collar part 6 contacts with the corner 34 of the horizontal face 32. Meanwhile, in a state where the front face 13 of the collar part 6 is separated from the positioning face (a state shown in FIG. 2B), the outer peripheral face 33 of the collar part 6 is put in non-contacting state with the corner 34. Accordingly, while the front face 13 of the collar part 6 is in contact with the positioning face 14, the ferrule 2 is prevented from moving in a direction (arrow Z direction in FIG. 2A) perpendicular to the axial direction (arrow X and F directions in FIG. 2A) of the optical fiber 4. On the other hand, when the front face 13 of the collar part 6 separates from the positioning face 14, the prevention or obstruction to the ferrule 2 is released or cancelled.

Accordingly, like the first embodiment, before the ferrule 2 is connected to a mating ferrule 2 (refer to FIG. 2A), the ferrule 2 is prevented from moving in all directions of the axial direction of the optical fiber 4 fixed in the ferrule 2 by adhesive and the direction perpendicular thereto. As a result, the position of the ferrule 2 is uniquely defined within the accommodating section 10 of the housing 1 for an optical connector. Meanwhile, when the ferrule 2 has been connected to the mating ferrule 2, the obstruction or prevention to the ferrule 2 is cancelled. Therefore, a sufficient clearance occurs between the ferrule 2 and the housing 1 for an optical connector, and the ferrule 2 is put in a floating condition within the accommodating section 10.

In the optical connector shown in FIGS. 2A and 2B, the horizontal faces 32 are formed on upper and lower sides of the expanded space 80, but they can be formed on both widthwise sides thereof. Also, horizontal faces 32 may be formed on upper, lower and both widthwise sides of the expanded space 80.

A method for connecting the optical connectors shown in the first embodiment or the second embodiment will be explained below. Herein, the connecting method will be explained as an example of the optical connector (the optical connector shown in FIGS. 1A and 1B) shown in the first embodiment.

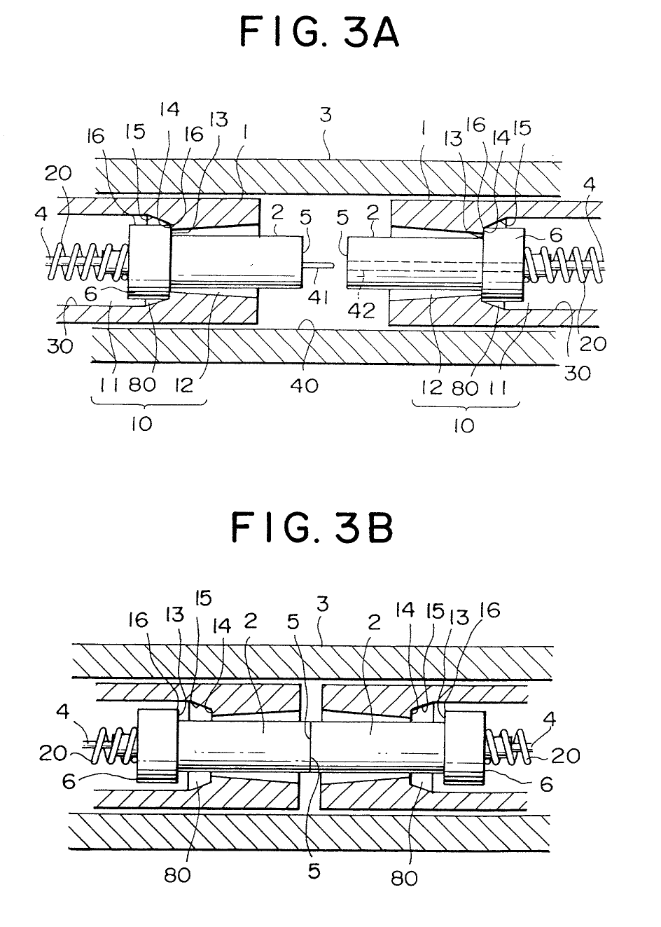

(1) Inserted into a cylindrical adapter 3 for connection such as shown in FIG. 3A from one of both longitudinal ends of the adapter 3 is the optical connector shown in FIG. 1A. Next, a similar optical connector is inserted into the adapter 3 from the other of the longitudinal ends of the adapter 3. The two optical connectors are inserted into the adapter 3 for connection such that the ferrule end faces 5 of the ferrules 2 are opposed to each other. Here, first ferrule 2 (the ferrule 2 on the left side in FIG. 3A) has two guide pins 41 on the ferrule end face 5. The first ferrule 2 has plural fiber holes between said two guide pins. Two guide pin holes 42 into which the guide pin 41 is inserted is formed in the ferrule end face 5 of second ferrule 2 (the ferrule 2 on the right side in FIG. 3A). The second ferrule 2 has plural fiber holes between said two guide pin holes.

(2) The two optical connectors within the adapter 3 for connection are caused to approach to each other according to guidance of an inner peripheral face 40 of the adapter 3 so that the guide pins 41 are inserted into the guide pin holes 42. In this course, the positions of the two ferrules 2 are uniquely defined within the accommodating sections 10 of the respective housings 1 for an optical connector. Therefore, an axial line of the guide pin 41 provided in a projecting manner on the ferrule end face 5 of one ferrule 2 and an axial line of the guide pin hole 42 formed in the ferrule end face 5 of the other ferrule 2 are necessarily coincident with each other. As a result, the guide pins 41 are inserted into the guide pin holes 42 smoothly and easily. Also, the guide pin 41 is prevented from coming in contact with the ferrule end face 5 of the mating ferrule 2 to injure the ferrule end face 5.

(3) The two optical connectors are caused to further approach to each other so that the ferrule end faces 5 of the ferrules 2 are caused to butt on each other, as shown in FIG. 3B.

According to the above procedure, the end faces of the optical fibers 4 fixed in the ferrules 2 are caused to butt on each other and the optical fibers 4 are optically connected to each other. In this state, the respective ferrules 2 are put in a floating condition within the respective housings 1 for an optical connector. Accordingly, even when the housing 1 for an optical connectors or the housing 3 for connection are inclined, each housing 1 for an optical connector is prevented from contacting with the ferrule 2 so that side pressure acting on the ferrule 2 does not occur.

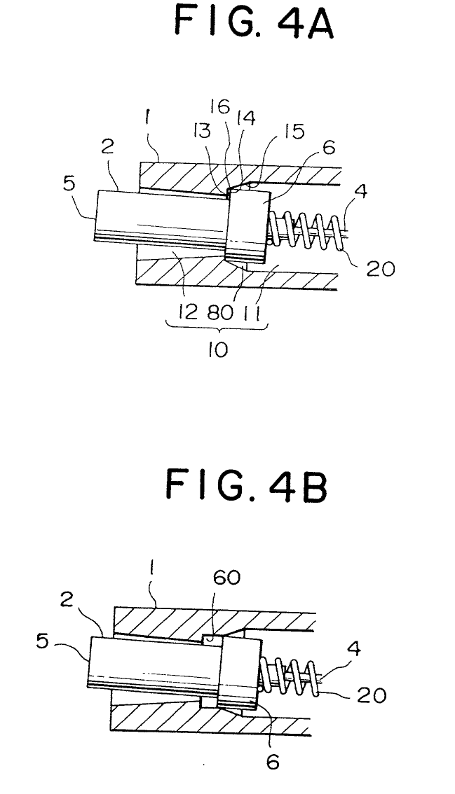

In order to disconnect the two optical connectors shown in FIG. 3B, the respective optical connectors are pulled outwardly so as to be separated from each other. In particular, respective rear ends of the housings 1 for an optical connector are pinched and the housings 1 are pulled away from each other. At this time, since the ferrules 2 are put in a floating condition within the respective housings 1 for an optical connector, there is a case that the ferrule 2 is inclined such as shown in FIG. 4A. In the optical connector of the present invention, however, the tapered face 15 is formed on the inner face of the accommodating section of the housing 1 for an optical connector. Accordingly, the ferrule 2 pushed out to the side of the ferrule end face 5 by the coil spring 20 returns back to a state shown in FIG. 3A without stabilizing the ferrule 2 in the state shown in FIG. 4A, while being guided by the tapered faces 15. Meanwhile, as shown in FIG. 4B, in the case where faces 50 opposed to the tapered faces 15 are horizontal, the ferrule 2 is fixed in a state shown in FIG. 4B by the pushing force of the coil spring 20.

[Third Embodiment]

Another embodiment of an optical connector of the present invention will be explained below. An optical connector shown herein is structured such that the ferrule fixing plural optical fibers is accommodated in a housing for an optical connector.

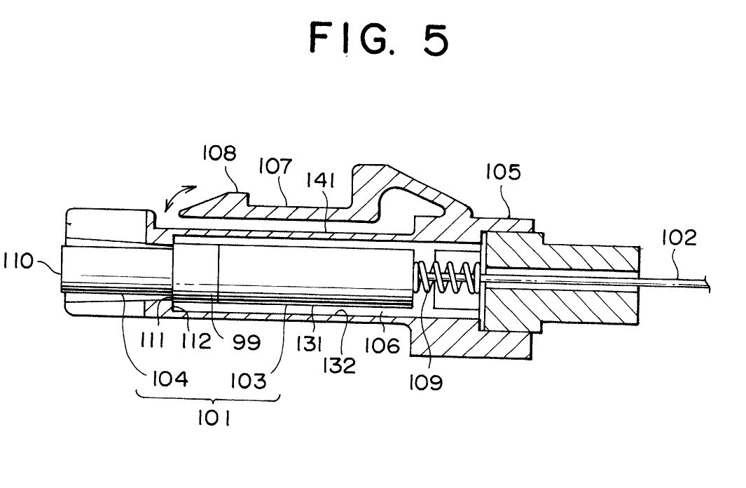

As shown in FIG. 5, a ferrule 101 is constituted by a mechanically splice portion 103 which guides plural optical fibers 102 and a MT portion (mechanically transferable portion) 104 into which the optical fibers 102 guided by the mechanically splice portion 103 is inserted.

As shown in FIG. 5, a housing 105 for an optical connector is provided with an accommodating section 106 which accommodates the ferrule 101 so as to be movable forward and rearward in an axial direction of the optical fiber 102. A thin latch 107 is formed integrally with the housing 105 for an optical connector so as to be positioned above the housing 105 and be elastic in directions shown by arrow. A projection 108 which is engageable with/disengageable from an engagement hole provided in an adapter for connection describe later is provided on a tip of the latch 107. A coil spring 109 is disposed at the rear of the ferrule 101 accommodated in the accommodating section 106, so that the ferrule 101 is always pushed forward in an axial direction of the optical fiber 102 (on the side of a ferrule end face 110). The ferrule 101 pushed to the ferrule end face 110 is positioned as a front face 111 of a collar part 99 is pushed onto a positioning face 112 in the accommodating section 106.

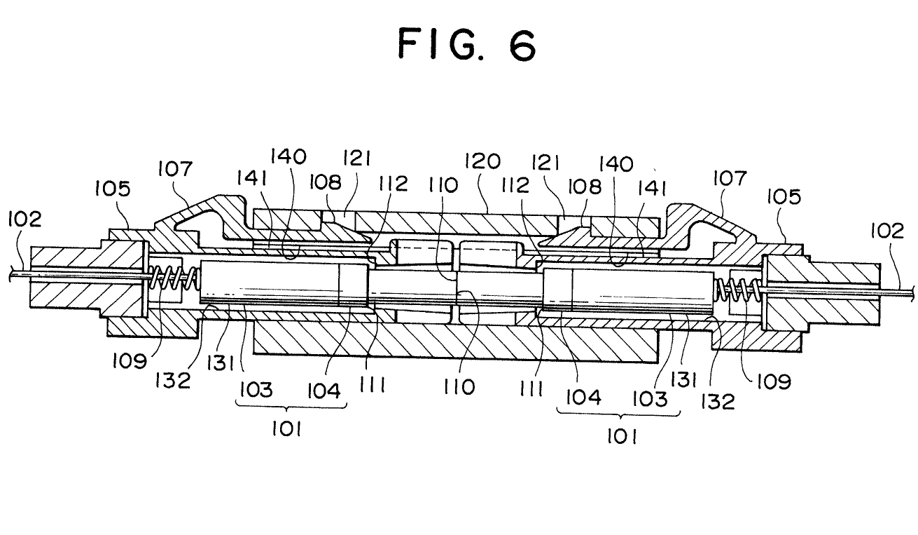

When the optical connectors shown in FIG. 5 are connected to each other, a cylindrical adapter for connection with a substantially rectangular shape is employed. In particular, the two optical connectors for connection are individually inserted into the adapter from both ends, in a longitudinal direction, of the adapter. Next, the two optical connectors which have been inserted into the adapter for connection are caused to approach to each other and the ferrule end faces 110 of the ferrules 101 are caused to butt on each other, as shown in FIG. 6. Thus, the optical fibers 102 attached to the respective optical connectors (the respective ferrules 110) are optically connected to each other. When both the optical connectors are caused to approach to each other until the ferrule end faces 110 of the ferrules 101 are caused to butt on each other, the respective projections 108 are automatically engaged with engagement holes 121 of the adapter 120 for connection. Thereby, both optical connectors are prevented from falling off from the adapter. Also, each ferrule 101 is moved backward against the pushing-out force of a coil spring 109 by the pushing force of the mating ferrule 101. Accordingly, as shown in FIG. 6, a front face 111 of the collar part 99 is separated from a positioning face 112. As a result, each ferrule 101 is maintained at a position where the pushing force of the mating ferrule 101 and the pushing-out force of the coil spring 109 are balanced to each other. At this time, an outer peripheral face 131 of the ferrule 101 and an inner peripheral face 132 of the accommodating section 106 are put in a completely non-contacting state, so that the ferrule 101 is put in a floating condition within the accommodating section 106.

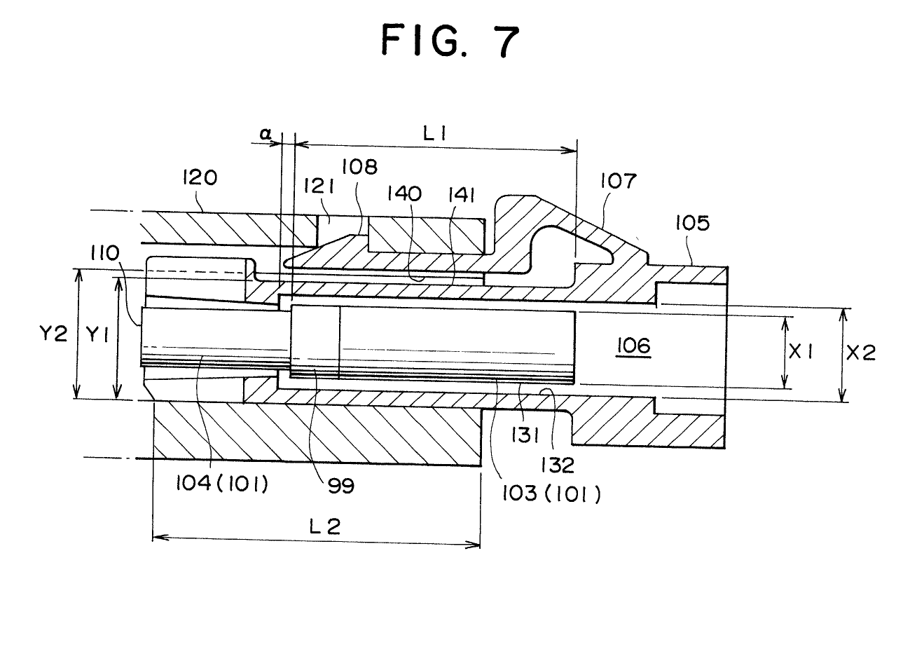

As mentioned above, the ferrule 101 in the housing 105 for an optical connector is moved forward and rearward in an axial direction of the optical fiber 102 after and before connection of the optical connectors. As shown in FIG. 7, it is assumed that the amount of movement is expressed as a. As shown in FIG. 7, it is also assumed that the length of a lager portion of an outer dimension (=the length of the collar part 99 and the length of the mechanically splice portion 103) of the ferrule 101 is expressed as L1 and the thickness thereof is represented as X1. It is assumed that the height of the accommodating section 106 of the housing 105 for an optical connector is expressed as X2. It is assumed that the thickness of a portion of the housing 105 for an optical connector which slides within the adapter 120 for connection is expressed as Y1. It is assumed that the height of a portion of the housing 5 which is positioned within the adapter 120 for connection is expressed as Y2. In this case, a clearance formed between the an inner peripheral face 140 of the adapter 120 for connection and an outer peripheral face 141 of the housing 105 when the adapter 120 for connection has been inserted into the optical connector is expressed as Y2−Y1. Furthermore, when it is assumed that an insertion length of the adapter 120 for connection to the housing 105 is L2, the maximum angle ω₀ where the housing 105 for an optical connector is allowed to incline in a range of the clearance is expressed as ω₀=arc tan {(Y2−Y1)/L2}. Also, an allowable angle ω₁ where, even when the ferrule 101 which has been accommodated in the accommodating section 106 of the housing 105 for an optical connector is inclined within the accommodating section 106, the outer peripheral face 131 of the ferrule 101 and the inner peripheral face 132 are not brought in contact with each other is expressed as ω₁=arc tan [{(X2−X1)/2}/(α+L1]. Accordingly, when the relationship of ω₀≦ω₁ is met, even when the optical connector which has been inserted into the adapter 120 for connection is inclined at the maximum angle, the inner peripheral face 132 of the accommodating section 106 is prevented from coming in contact with the outer peripheral face 131 of the ferrule 101. Therefore, in the optical connector of the present invention, the respective values or parameters of X1, X2, Y1, Y2, L1, L2 and α are designed such that the relationship of ω₀≦ω₁ is met. One example of specific design parameters is shown in Table 1. Also, one example of design parameters of a conventional optical connector is shown in Table 2.

TABLE 1

| X1 | X2 | Y1 | Y2 | L1 | L2 | α |
|---|---|---|---|---|---|---|
| 3.0 mm | 3.5 mm | 4.61 mm | 4.78 mm | 15 mm | 13 mm | 0.75 mm |

TABLE 2

| X1 | X2 | Y1 | Y2 | L1 | L2 | α |
|---|---|---|---|---|---|---|
| 3.0 mm | 3.5 mm | 4.61 mm | 4.78 mm | 15 mm | 13 mm | 0.75 mm |

When a design is conducted according to the design parameters shown in Table 1, ω₀=0.75 and w1=0.91 are obtained, which meets the relationship of ω₀≦ω₁. on the other hand, a design is conducted according to the design parameters shown in Table 2, ω₀=0.75 and ω₁=0.54 are obtained, which does not meet the relationship of ω₀≦ω₁.

[Fourth Embodiment]

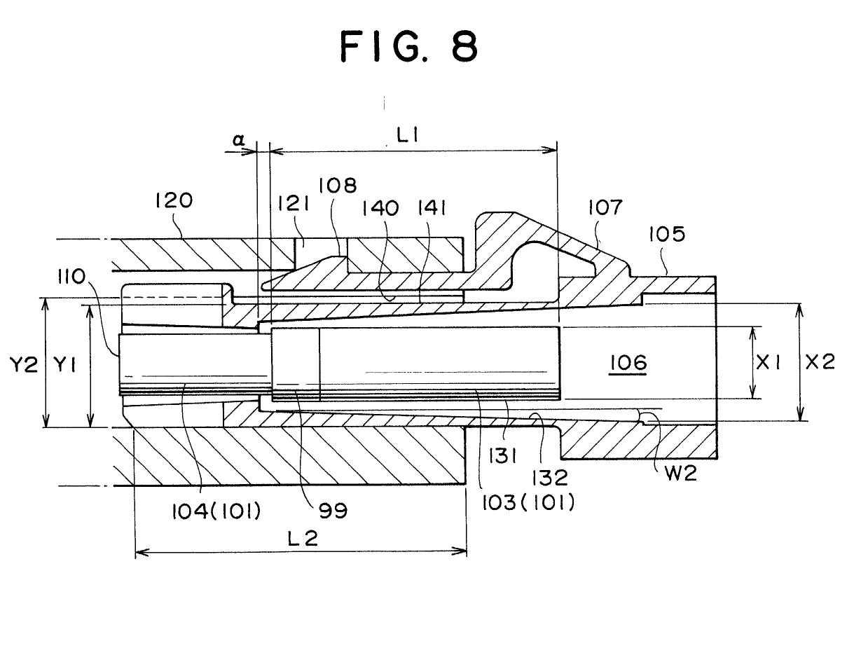

Another embodiment of the optical connector of the present invention will be explained with reference to FIG. 8. A basic constitution of an optical connector shown in FIG. 8 is the same as that of the third embodiment. Both embodiments are different in a point that the inner peripheral face 132 of the accommodating section 106 of the housing 105 for an optical connector is formed in a tapered face. The inclination angle ω₂ of the inner peripheral face 132 is set to be larger than an angle formed by the inner peripheral face 140 of the adapter 120 for connection and the outer peripheral face 141 of the housing 105 for an optical connector when the optical connector which has been inserted into the adapter 120 for connection is inclined at the maximum angle within the adapter 120. Accordingly, even when the optical connector which has been inserted into the adapter 120 for connection is inclined in the maximum range within the adapter 120, the inner peripheral face 132 of the accommodating section 106 is prevented from coming in contact with the outer peripheral face 131 of the ferrule 101.

### EFFECT OF THE INVENTION

According to the housing for an optical connector of the present invention, at least one of the following effects (1) and (2) can be achieved.

(1) The position of the ferrule which has been accommodated in the housing for an optical connector of the present invention can be uniquely defined or determined within the housing until the ferrule is brought into contact with a mating ferrule. Accordingly, when the ferrule end faces of two ferrules which have been accommodated in the housing are caused to butt on each other, the axial lines of both ferrules are securely coincident with each other. As a result, the ferrule end faces of the two ferrules can be caused to butt on each other smoothly and easily. Also, when one of the ferrules is provided with two guide pins in a projecting manner, the guide pins are prevented from coming in contact with the ferrule end face of the other ferrule to injure the ferrule end face.

(2) When the ferrule which has been accommodated in the housing for an optical connector of the present invention has been connected to a mating ferrule, it is put in a floating condition within the housing. Accordingly, even when the housing is inclined due to any cause after connection, side pressure is prevented from acting on the ferrule within the housing. As a result, a transmission loss is prevented from fluctuating. Also, when disconnection is conducted, the ferrule in the housing is prevented from being fixed in an inclined condition.

According to the optical connector of the present invention, at least one of the following effects (1) and (2) can be obtained.

(1) The optical connector of the present invention is structured by accommodating the ferrule fixing the optical fiber in the housing having the above effect(s). Accordingly, the effect(s) the same as that (those) of the housing for an optical connector can be obtained in the optical connector.

(2) In the optical connector of the present invention, even when the optical connector which has been inserted into the adapter for connection is inclined in the maximum range within the adapter for connection, the housing for an optical connector and the ferrule do not come into contact with each other. Accordingly, in a state where two optical connectors are put in a connected condition, even when the housing for an optical connector is inclined due to any cause, side force is prevented from acting on the ferrule according to the inclination. As a result, a stable connection can be secured, and there is no possibility that the ferrule is injured by side force.

What is claimed is:

1. A housing where a ferrule is accommodated, comprising:
(1) an accommodating section which accommodates a ferrule fixing at least an optical fiber so that the ferrule can be movable in an axial direction of the optical fiber in the accommodation section;
(2) an expanded space formed by a positioning face which can come into contact with a front face of a collar part of the ferrule to position the ferrule and at least one tapered face which expands outward from the positioning face rearward in the axial direction of the optical fiber, which is provided in the accommodating section, wherein
(3) when the front face of the collar part of the ferrule which has been accommodated in the accommodating section separates from the positioning face, the collar part is put in non-contacting state with an inner peripheral face of the accommodating section within the expanded space.

2. An optical connector where a ferrule fixing at least an optical fiber is accommodated in an accommodating section of housing for an optical connector, wherein
(1) an expanded space formed by a positioning face which can come into contact with a front face of a collar part of the ferrule to position the ferrule and at least one tapered face which expands outward from the positioning face rearward in the axial direction of the optical fiber is provided in the accommodating section of the housing for an optical connector;
(2) the ferrule which has been accommodated in the accommodating section is movable in the axial direction of the optical fiber;
(3) before connection to another optical connector, the front face of the collar part of the ferrule is put in contact with the positioning face; and
(4) after connection of the another optical connector, the front face of the collar part of the ferrule separates from the positioning face so that the collar part is put in non-contacting state with an inner peripheral face of the accommodating section within the expanded space.

3. An optical connector where a ferrule fixing at least an optical fiber is accommodated in an accommodating section of a housing for an optical connector, wherein
(1) a positioning face which can come in contact with a front face of a collar part of the ferrule to position the ferrule is formed within the accommodating section of the housing for an optical connector;
(2) an outer peripheral face of the collar part of the ferrule is formed in a tapered shape expanding outward from a ferrule end face side towards an opposite side;
(3) the ferrule which has been accommodated in the accommodating section is movable in an axial direction of the optical fiber;
(4) before connection to another optical connector, the front face of the collar part of the ferrule comes into contact with the positioning face and an outer peripheral face of the collar part comes into contact with an inner peripheral face of the accommodating section; and
(5) after connection to another optical connector, the front face of the collar part of the ferrule separates from the positioning face and the outer peripheral face of the collar part separates from the inner peripheral face of the accommodating section.

4. An optical connector which is inserted into a cylindrical adapter for connection to butt on another optical connector which has been inserted into the adapter, wherein
(1) a ferrule fixing at least an optical fiber is accommodated in an accommodating section of a housing for an optical connector;
(2) the ferrule which has been accommodated in the accommodating section is movable in an axial direction of the optical fiber;
(3) a clearance is provided between an inner peripheral face of the accommodating section and an outer peripheral face of the ferrule; and
(4) the clearance is set to have such a size that, even when the optical connector which has been inserted into the adapter for connection is inclined at the maximum angle in the adapter, the inner peripheral face of the accommodating section and the outer peripheral face of the ferrule does not come into contact with each other.

5. An optical connector according to claim 4, wherein
(1) the inner peripheral face of the accommodating section of the housing for an optical connector is formed in a tapered face; and
(2) an inclined angle of the tapered face is set to be larger than an angle formed by an outer peripheral face of the housing for an optical connector and an inner peripheral face of the adapter for connection which are opposed to each other when the optical connector inclines at the maximum angle within the adapter for connection.
